(19) United States
(12) Patent Application Publication
(10) Pub. No.: US 2005/0179412 A1
(43) Pub. Date: Aug. 18, 2005

(54) Arrangement for carrying out a method for a controlling a multi-phased and reversible rotating electrical machine associated with a heat engine of a motor vehicle

(75) Inventor: Dominique Sebille, Arcueil (FR)

Correspondence Address: OSHA LIANG L.L.P., 1221 MCKINNEY STREET, SUITE 2800, HOUSTON, TX, 77010, US

(73) Assignee: Valeo Equipements Electriques Moteur, Creteil (FR)

(21) Appl. No.: 10/510,424

(22) PCT Filed: Apr. 11, 2003
(86) PCT No.: PCT/FR03/01167

(30) Foreign Application Priority Data
Apr. 12, 2002 (FR) 02/05098

(51) Int. Cl. H02J 7/00

(52) U.S. Cl. 318/139

(57) ABSTRACT

The invention relates to an arrangement for carrying out a method for controlling a multi-phased and reversible rotating electrical machine associated with a heat engine of a motor vehicle. Said arrangement comprises a network for supplying electrical energy, a battery which is connected to said network, an energy storage device (9) which can be connected to the rotating electrical machine (1) by a switching device (6), a DC to DC converter (4) which is mounted between the energy supply battery (2) and the energy storage device (9), downstream from the switching device (6), and a circuit (7) which can directly connect the rotating electrical machine (1) to the battery (2). A switch (T1) is provided in said circuit (7).

### BACKGROUND OF INVENTION

1. Field of the Invention

The invention relates to an arrangement for carrying out a method for controlling a multi-phased and reversible rotating electrical machine associated with a heat engine of a motor vehicle, which includes a network for supplying electrical energy and a battery serving as a source of electrical energy connected to this network, as well as a command and control unit for the machine.

2. Background Art

Although methods and arrangements of this type are already known, it has been found that rotating electrical machines have properties that can be exploited for the execution of certain functions associated with the vehicle, which have not been considered until now or which require complex and expensive means.

Thus, in view of document FR A 2 802 363, which describes means for supplying an overexcitation voltage to the trip coil of the rotor of the machine, one can envision employing a method in which the overexcitation of the machine for a brief period of time produces energy and supplies this energy for the execution of certain functions associated with the vehicle.

The arrangement for carrying out the method may include a device for supplying, via the electrical network of the vehicle, the energy which was produced during the brief period of overexcitation of the machine.

This device for supplying energy advantageously consists of an energy storage device that can be connected to the rotating electrical machine by means of a switching device.

The arrangement may also include, downstream from the switching device, a DC to DC device mounted between the battery and the energy storage device.

This converter is a high-power converter.

### SUMMARY OF INVENTION

The purpose of the present invention is to reduce, in a simple and economical way, the power and size of the converter.

The arrangement of the above-mentioned type is characterized in that it includes a circuit that can directly connect the rotating electrical machine to the battery, by means of the switching device, and in that a switch is provided in the above-mentioned circuit.

Thanks to the invention, the switch is mounted in parallel with the converter. Thus, the energy produced during the overexcitation of the machine is stored in the storage device that can return the stored energy; the machine is overexcited during braking; and the energy recovered during this braking is stored.

Thus, thanks to the invention, a smaller and lower-power converter can be used. The power of the converter may be determined according to the operational arrangement in braking recovery mode according to the invention.

The switch is advantageously of the static type, consisting, for example, of a MOSFET transistor.

### BRIEF DESCRIPTION OF DRAWINGS

The invention will be better understood, and other pertinent goals, characteristics, details, and advantages will become more clear, through a reading of the following explanatory description, which refers to the attached schematic drawings, which are provided solely as examples, which illustrate one embodiment of the invention, and on which:

FIG. 1 illustrates, in schematic form, the principal of an arrangement according to the invention;

FIG. 2 illustrates a first embodiment of the arrangement according to FIG. 1;

FIG. 3 illustrates a second embodiment of the arrangement according to FIG. 1; and

FIGS. 4 through 9 illustrate various different uses of the arrangement according to FIG. 2.

### DETAILED DESCRIPTION

The invention relates to a reversible rotating electrical machine such as the alternator-starter of a motor vehicle.

As is known, every rotating electrical machine includes a stator and a rotor that are mounted coaxially, with the stator being carried by a fixed support consisting of a front bearing and a rear bearing, each of which includes bearing means, such as a ball bearing, for the assembly of a rotative shaft that forms an integral part of the rotor, in the manner described hereinbelow.

The alternator makes it possible to transform a rotary movement of the inductor rotor, driven by the heat engine of the vehicle, into an electrical current induced in the stator windings. The alternator may also be reversible, and may be an electric motor, in which case its stator constitutes an inductor and its rotor constitutes an armature, which, via the rotor shaft, induces the rotation of the thermal engine of the vehicle. This reversible alternator is known as an alternator-starter, and makes it possible to transform mechanical energy into electrical energy, and vice versa. Accordingly, an alternator-starter can start the engine of the automotive vehicle, serve as an auxiliary motor (for example, to drive an air-conditioning compressor), or operate in motor mode to drive the automotive vehicle. Generally speaking, the stator includes three coils, such that the alternator is of the three-phase type. As a variant, the alternator is of the six-phase type, and can be wound with conductor bars forming U-shaped pins. When the alternator-starter is operating in starter mode or in motor mode, it must transmit a very high torque to the heat engine.

Thus, this multi-phased and reversible machine operates as an alternator (in particular to charge the battery of the vehicle and to supply electrical power to the electrical consumers), and as a starter (to drive the internal-combustion engine, also known as a heat engine, of the automotive vehicle in order to start it).

For this purpose, the rectifier bridge located at the output of the alternator armature makes it possible to rectify the alternating current of the armature, and also serves as a control bridge for the phases of the alternator. This bridge is known as an inverter, and includes MOSFET-type transistors, as described, for example in documents FR-A-2745444 and FR-A-2745445.

It is known that this rotating machine, constituting an alternator, includes:

A coiled rotor constituting the inductor, which is traditionally associated with two collector rings connected to the extremities of the rotor winding, and two contact brushes via which the excitation current is carried, which brushes are carried by a brush carrier connected to a voltage regulator.

A multi-phased stator carrying multiple coils or windings constituting the armature, which coils or windings are connected in a star shape or in the shape of a triangle, in the most frequent case of a three-phased structure, and delivers the converted electrical current to the rectifier bridge, while operating as an alternator.

The bridge rectifier is connected to the different phases of the armature, and is mounted between the ground and a battery supply terminal. This bridge rectifier includes, for example, diodes associated with MOSFET-type transistors.

In order to cause such an alternator to function in electric-motor mode, for example, a direct current is applied to the inductor, and signals that are phase-offset by 120° are delivered synchronously to the phases of the stator. The said signals are ideally sinusoidal signals, but may also be trapezoidal or square waves, as described in the above-mentioned documents FR-A-2745444 and FR-A-2745445.

This control and rectifier bridge is driven by an electronic control module. The bridge and the control module belong to a unit, known as a command and control unit, usually located outside the machine. This unit is also a management unit, and includes a microcontroller.

Means are also provided for monitoring the angle position of the rotor, so that, in electric-motor mode, electrical current can be injected at the proper time into the appropriate stator coil.

These means, which are advantageously of the magnetic type, send information to the electronic control module, and are described, for example, in documents FR-2 807 231 and FR-2 806 224 (WO 01/67962).

Thus, these means include a rotatively fixed target mark on the rotor or the pulley of the machine, and at least one Hall-effect or magneto-resistive sensor detecting the passage of the target mark, which is advantageously of the magnetic type.

At least three sensors are preferably provided, which are carried by the front or rear bearing that forms a part of the rotating electrical machine, in order to support the stator in a fixed manner and in order to support the rotor rotatively.

In certain cases, it is desirable to improve the start-up performance of an alternator-starter. Accordingly, the rotor winding can be overexcited in order to obtain more starting torque.

This overexcitation can be achieved by an overvoltage at the terminals of the trip coil, and/or an overcurrent in the trip coil, in comparison with a traditional alternator.

Here, this machine has the structure of a traditional alternator, such as, for example, the type described in document EP-A-0 515 259 (U.S. Pat. No. 5,270,605), which contains further details.

Thus, this machine has internal ventilation (it is air cooled), and its rotor includes, at least at one of its axial extremities, a fan mounted inside the support, with the hollow front and rear bearings which include air inlets and outlets in the manner described hereinbelow. As a variant, the machine is water cooled.

More specifically, the rotor is a claw-type rotor, with polar wheels bearing, on their external periphery, axially oriented and trapezoidal teeth.

The teeth of one polar wheel are directed toward the teeth of the other polar wheel; these teeth, which are generally trapezoidal, are distributed in an interleaved manner from one polar wheel to the other. Naturally, as described, for example, in document FR-A-2 793 085, permanent magnets may be placed between the teeth of the polar wheels in order to increase the magnetic field.

The rotor carries a trip coil between the flanges of its polar wheels. This coil includes an electrically conductive element that is wound with the formation of spiral turns. This coil is a trip coil which, when it is activated, magnetizes the rotor in order to create, with the aid of the teeth, an alternation of the North and South magnetic poles. Each end of the rotor coil is swept by a contact brush and is connected to a collector ring. The brushes are carried by a brush carrier that forms an integral part of the rear bearing of the machine, centrally carrying a ball bearing which rotatively supports the rear end of the bearing shaft that forms an integral part of the rotor.

In another embodiment, the rotor is a hybrid rotor that is excited by a coil and by magnets, as described, for example, in documents WO 02/054566 and U.S. Pat. No. 6,147,429, which contain further details. In this case, the rotor includes a group of plates which, on the one hand, contain recesses intended to receive permanent magnets, and which, on the other hand, are cut out for the formation of projecting poles around which trip coils are wound. The recesses are closed axially at each of their ends by a retaining element that includes a non-magnetic part intended to come into contact with the magnets, and to serve as a stop. The retaining element has recesses intended to receive windings, trip coils, and also includes fan blades. A rotor of this type may, for example, be of the type with smooth poles.

The front end of the shaft is supported rotatively by a ball bearing carried by the front bearing of the machine. The front end of the shaft includes, at the exterior of the machine, a drive unit, such as a pulley, belonging to a motion-transmission device that includes at least one belt that is in contact with a pulley. The movement transmission device establishes a link between the pulley and a unit, such as another pulley, that is driven rotatively by the internal-combustion engine of the vehicle. As a variant, the movement transmission device is a chain-type device, i.e. the drive unit has teeth that fit/operate with the chain. As a variant, the transmission device consists of a gear mechanism.

When the machine, which in this case is an alternator-starter, operates in alternator mode (that is, when it operates as an electrical generator), the pulley is driven rotatively by the internal-combustion engine of the vehicle, at least by means of the above-mentioned belt. When the machine functions in the starter mode (that is, when it functions as an electric motor), the pulley rotatively drives the engine of the vehicle by means of the belt.

The front and rear bearings are open for the internal ventilation of the machine; are connected to each other (for example, by means of tie rods); and are part of the support of the machine intended to be affixed to a stationary part of the vehicle.

As a variant, at least one of the bearings has a channel for the circulation of a cooling fluid, such as the cooling fluid used by the engine of the vehicle, and for the cooling of the machine.

This support includes, affixed to its external periphery, the body of a stator that usually consists of a set of plates which have slots for the installation of the coils or, more generally speaking, stator windings, whose outputs are connected to the above-mentioned inverter and control bridge.

The stator coils or windings consists of wires or bars of windings, as described, for example, in document WO 92/06527. The bars may have a rectangular cross-section. As a variant, the windings may consist of wires, and a single slot in the body of the stator may contain a three-phase star-winding and a three-phase triangle winding, whose outputs are connected to the bridges of diodes, as described in documents FR A 2 737 063 and U.S. Pat. No. 4,163,187.

The stator surrounds the rotor, whose contact brushes are connected to an alternator regulator, in order to keep the voltage of the alternator at a desired voltage, which here is about 14V for a 12V battery.

Here, the rectifier bridge, the electronic command-and-control unit of the rectifier bridge, and the regulator are mounted in an electronic housing located outside the machine. This housing includes switching means (including power switches), a control unit, and an overexcitation circuit. The overexcitation circuit is active in starter mode, in order to maximize the starting torque of the alternator-starter and thereby to more easily start the internal-combustion engine, known also as the heat engine, of the automotive vehicle, during either a cold start or a start after (for example) a stop at a stoplight, after the motor has been turned off in order to reduce fuel consumption, thereby performing a so-called “stop-and-go” function.

This overexcitation circuit receives, at its input, the voltage from the onboard network delivered by the battery and/or the alternator. It then delivers, to the terminals of the trip coil, a voltage that is higher than the said voltage of the onboard network.

The command-and-control unit for the electrical machine may include means which, if the alternator-starter is discharged onto the onboard network (having been disconnected from the battery, as occurs in the case of a “load dump,” to use the Anglo-Saxon terminology generally preferred by those skilled in the art), allow the immediate control of the opening of a power switch that provides energy to the trip coil, so as to cause the rapid demagnetization of the alternator (specifically, of its rotor). For more details, see, for example, documents FR-A-2 802 365 and FR-A-2 802 361.

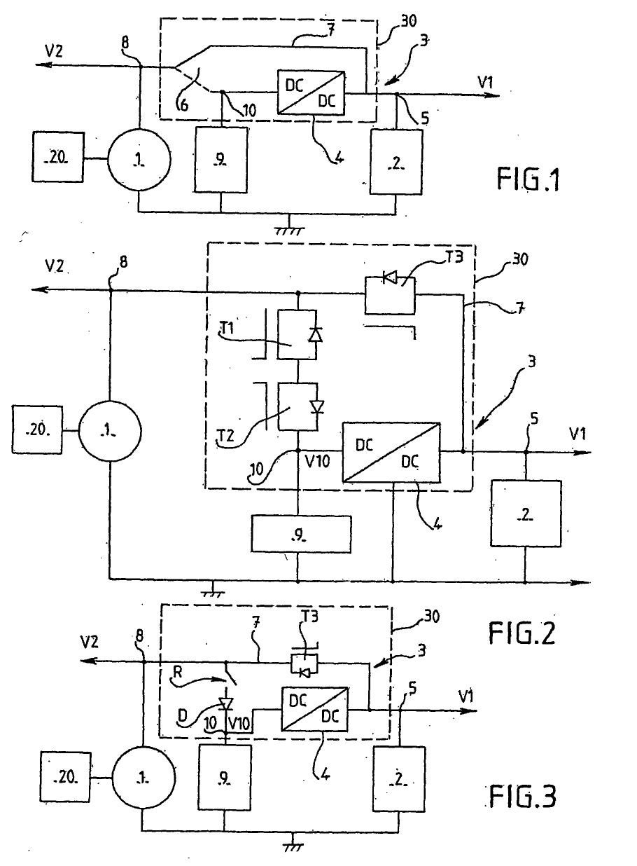

More specifically, the invention relates to an arrangement allowing the exploitation of the strong electrical power that the rotating electrical machine can produce, during a brief period of time, in the overexcitation state. FIG. 1 illustrates the principle of the structure or architecture of such an arrangement. On this figure, the reference numbers [1] [2] and [3] designate an alternator-starter, the battery, and the electrical energy supply network of the vehicle. Reference number [4] indicates a converter that converts direct current into direct current (DC/DC), so as to allow operation at two different voltages [V1] [V2]. This converter is mounted between a terminal [8] of the machine [1] and the terminal [5] with the corresponding polarity of the battery [2], by means of a switching device [6]. Advantageously, the DC converter [4] and the switching device [6] are located in the same electronic housing [30] for management of the onboard network of the vehicle. When the switch is in the position indicated by the dashed line, it connects the terminal [8] of the output of the stator coil of the machine to the terminal [10] of the converter, whose other terminal is connected to the terminal [5] of the battery. In its second position, the switch opens the converter circuit and closes an electrical circuit [7] that directly interconnects the terminal [8] of the machine and the terminal [5] of the battery. As can be seen, the machine and the battery are directly and permanently connected to ground via their other terminal.

Thus, the network [3] includes, at the right of the converter [4], on the battery [2] side, an initial voltage [V1] that is advantageously regulated by the command-and-control unit, which is advantageously contained in the same electronic housing [20] that controls the electrical machine, for example, at a value of 14 volts.

As indicated earlier, this electronic housing [20] that controls the electrical machine advantageously includes the rectifier bridge, the electronic control unit for the rectifier bridge, and the regulator, as well as a circuit for the overexcitation of the rotor of the electrical machine.

Advantageously, communications link is provided between this electronic housing [20] for the control in command of the electric machine, and the housing [30] for the management of the onboard network of the vehicle. This communications link may, for example, consists of the CAN type that is currently utilized in automotive electronics.

On the other side of the converter, the voltage [V2] may vary between the value of the regulated voltage [V1] and a higher voltage. For example, this voltage may vary between 14 volts and 21.5 volts.

According to one characteristic of the invention, the switching device [6] makes it possible to connect, to the alternator-starter [1], an energy storage source [9], which is mounted between the ground-connected terminals of the electrical machine [1] and of the battery, and the terminal [10] of the converter [4] on the high-voltage side [V10] of the converter. Thus, the switch [6] connects the machine [1] either to the network [3], or to the energy storage device [9] and to the converter [4]. The converter is advantageously of the static type.

According to another advantage characteristic of the invention, this energy storage device consists of a capacitor device, which is advantageously a device known as a double-layer capacitor or a supercapacitor, which consists of a plurality of capacitor cells mounted in series.

This energy storage device has a very low internal resistance, and therefore becomes only very slightly heated. The super capacitor [9] may be charged to the value of the variable voltage [V2] on the left side of the converter, that is, on the alternator-starter [1] side, which, in the example given, may be a value of 21.5 volts. In this case, the supercapacitor may consist of eight cells, each of which has a voltage range from 1.4 to 2.7 volts.

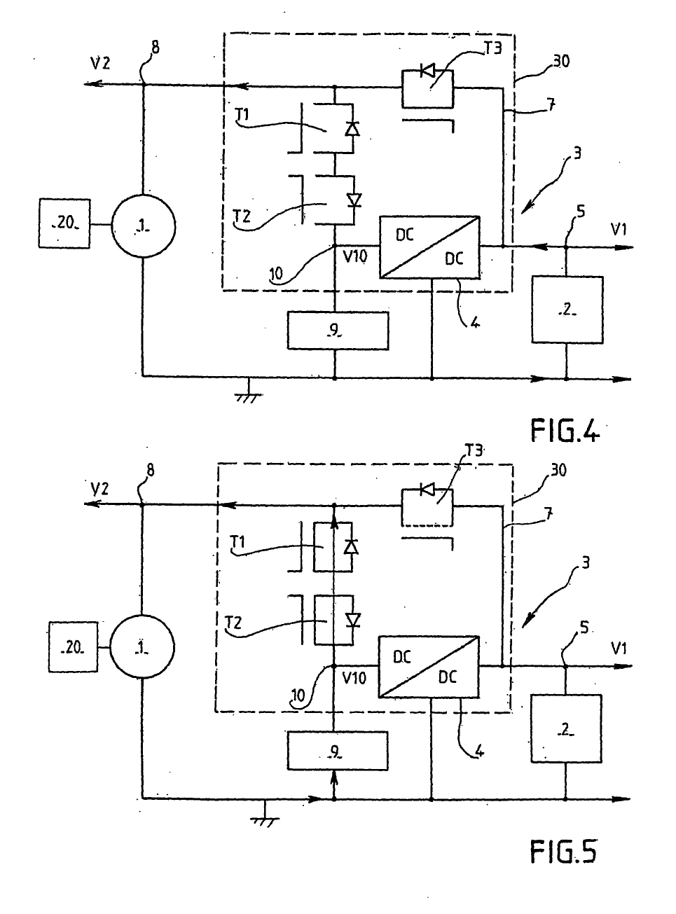

FIG. 2 shows a first preferred embodiment of the arrangement shown in FIG. 1. In this embodiment, the switching device [6] includes two MOSFET-type transistors [T1] [T2], which operate as switches and are mounted head-to-tail between the connection point [10] of the converter [4] and of the supercapacitor [9], which point [10] is brought to a voltage [V10], and the terminal [8] of the electrical machine [1], and a third switch according to the invention, which here is a MOSFET-type transistor [T3] mounted between the terminal [8] and the connection point [5] of the battery [2] and of the converter [4], in circuit [7].

According to the invention, this third switch [T3] is mounted in parallel with the DC/DC converter.

The operation of the arrangement shown in FIG. 2, and certain advantageous uses thereof, are described below.

The arrangement has been designed in such a way that, under normal excitation conditions (such as, for example, when the vehicle is running at cruising speed), the microcontroller serving as the regulator, located in the command and control unit [20] of the electric machine, regulates the voltage [V1] to the nominal set value, such as, for example, 14 volts.

It should be noted that the microcontroller limits the excitation current to a value lower than the maximum value, in order to avoid excessive heating of the coils of the machine.

Conversely, when the driver of the vehicle operates the brakes, the control unit first causes a change in the position of the switch [6], which thus is shifted from the position shown in solid lines in FIG. 1 to the position shown in this figure in dashed lines, in which the supercapacitor [9] is placed in the circuit. Furthermore, the controller does not limit the excitation or provide any other nominal set of values, as long as the excitation level of the machine, operating in generator mode, can be increased. Because the machine is not connected to the network, a greater amount of torque can be drawn from the motor, and the voltage at the terminals of the machine can be increased to the maximum admissible value. Thus, the supercapacitor [9] is charged during part of the braking period, which is relatively brief, in order to avoid excessive heating of the coils of the machine.

In the arrangement shown in FIG. 2, during such a braking activity, the controller causes the opening of the MOSFET switch [T3] and the closing of the MOSFET switches [T1] and [T2], which are normally open, so that the supercapacitor [9] can be charged by the machine [1]. The arrangement according to the invention thus ensures the recovery of the braking energy, such that the term “recuperative braking” can be employed.

Because this method of recovering energy during braking involves very frequent actuation of the switch [6] (more than 500,000 times during the lifetime of the vehicle), it can easily be understood that the use of a static switch device consisting of MOSFET transistors, as proposed by the invention, is more advantageous than switches of the electromagnetic relay type or other mechanical switches.

The two MOSFET transistors [T1] and [T2] mounted head-to-tail in series with the supercapacitor were chosen because the switching device [6] may see a voltage difference [V2]−[V10] in both directions (that is, in the direction from [V2] to [V10] or from [V10] to [V2]) for example, when the supercapacitor [9] is discharged. Consequently, the switch can block the voltage in both directions, when the vehicle is in its normal operating mode and also when the vehicle is in its recuperative braking mode. The head-to-tail mounting of the MOSFET transistors, as shown in FIG. 2, allows these functions to be implemented. FIG. 7 illustrates the functioning of the arrangement in recuperative braking mode. The arrows indicate the flow of the charging current for the supercapacitor [9], through the MOSFET switches [T1] and [T2], which are closed, while the MOSFET switch [T3] is open.

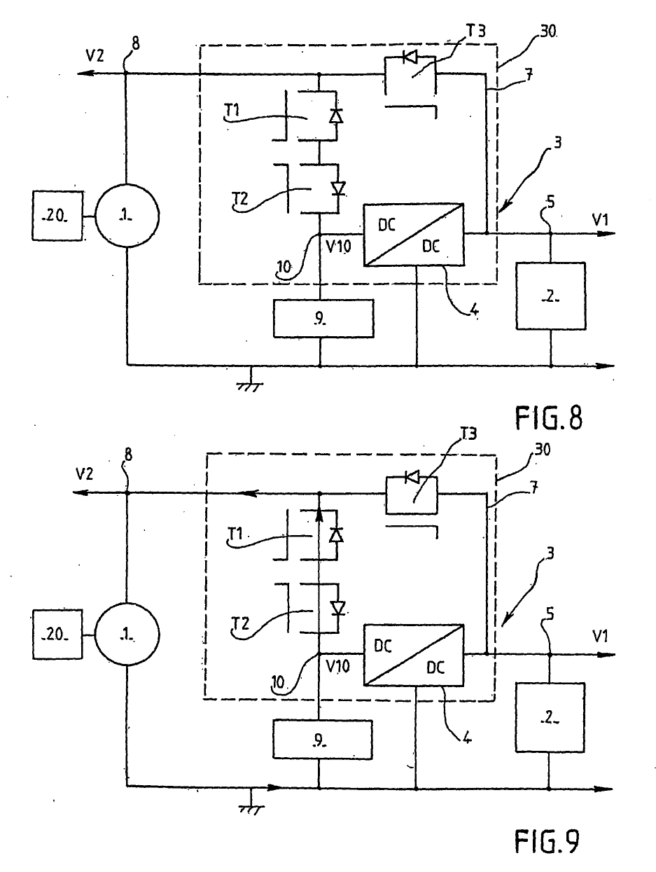

FIGS. 4 to 6, 8, and 9 illustrate the arrangement and other operating modes. The closed state of the MOSFET switches, and thus the passage of current, is symbolized by a thin arrow. The arrows indicate the direction of flow of the currents.

FIG. 4 illustrates the case in which the rotating electrical machine [1] is, operating in starter mode, while being supplied from the battery. As can be seen, the MOSFET [T3] is closed, thereby short-circuiting the converter [4]. The MOSFET switches [T1] and [T2] are open, and isolate the supercapacitor [9].

FIG. 5 also illustrates the case in which the machine and the arrangement according to the invention are operating in starter mode. However, this time, the energy is supplied by the supercapacitor [9] constantly, the MOSFETs [T1] and [T2] are closed, thereby allowing passage [of the current], while the MOSFET [T3] is open. The latter MOSFET can be closed if the supercapacitor voltage drops below the battery voltage.

FIG. 6 illustrates operation in alternator mode, in which energy is supplied by the network [3]. In this case, the MOSFET switch [T3] is closed, thereby allowing passage [of the current], while the MOSFET switches [T1] and [T2] are open. Energy can also be supplied to the network [3] through the discharge of the supercapacitor [9] via the converter [4], as shown in FIG. 8.

The three switches [T1] [T2] [T3] are then open. The network can also be supplied with energy by both the machine [1] and the supercapacitor. Thus, if necessary, part of the energy network of the vehicle can be supplied under voltage greater than the standard voltage of between 14 and 30 volts.

FIG. 9 illustrates the particularly specific case according to the invention in which the machine must be able to work with charges that require high-power levels, for example, to perform electrically assisted [i.e., power] steering functions or to provide passenger-cabin heating services. The energy is then supplied by the alternator, which is set to a voltage greater than the network voltage. As in the case shown in FIG. 4, switch [T3] is open. Energy is supplied to the consumers by the alternator, in parallel with the supercapacitor, i.e., from a source with very low internal impedance, which is particularly suitable for supplying (for example) power-steering units, whose current peaks are a known problem.

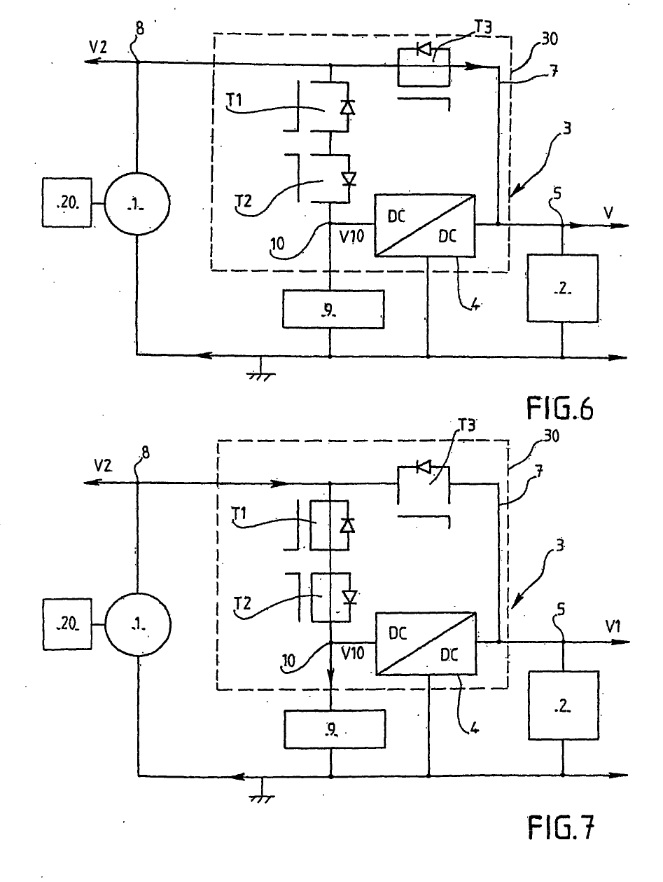

Now, with reference to FIG. 3, a second embodiment of the invention will be described. In this embodiment, the switching device [6] no longer consists of the two MOSFET transistors [T1] and [T2], but rather of a diode [D] with which a switch [R], which may be an electromagnetic relay, is mounted in series. The presence of the MOSFET transistors [T1] and [T2] is advantageous for high-power operation under the effect of the supercapacitor [9]. However, it has been found that for operation when energy is supplied by the battery [2], and when starting with the supercapacitors is not possible, a simple diode [D] is sufficient to fulfill the function of the two transistors, thereby making it possible to reduce the size and cost of the switching device. Because of the problem involving the pre-charging of the supercapacitor [9] when its voltage is lower than that of the battery, the relay [R] has been placed in series with a diode, to avoid the flow of current from the battery to the supercapacitor.

The diode [D3] may be a diode of the so-called “press-fit” type, which is a solution that occupies very little space. Naturally, the MOSFET transistors [T1] and [T2] may also be replaced by a high-reliability relay, which would allow the costs to be reduced even further.

To go even further in the area of cost reduction, the supercapacitor could also be replaced by a battery, such as, for example, an 18-volt battery for a 14-volt network. However, in this case, the battery would have to be replaced during the lifetime of the vehicle.

As mentioned earlier, the function of the switch [T3] is to protect the machine from a polarity inversion. However, because there is always a risk of polarity inversion on a 14-volt network, it has been proposed, in the case of the invention, that yet another level-setting diode (not shown) be provided, with a fuse mounted in series. This way, the output of the converter is protected against any polarity inversion of the connection of the battery [2]. In the case of an inverse connection, current will flow through the diode and the fuse, causing the fuse to melt. In all cases, the switch [T3], mounted in parallel with the DC/DC converter, makes it possible to limit the power of this converter, which thereby becomes more economical. During normal operation, this converter is short-circuited by the switch [T3], in the manner described below.

The MOSFET transistors are advantageously transistors intended for high current levels. When the intention is to ensure a start, with either a 14-volt battery or the supercapacitor (for example, at a current of 600 amps for 200 milliseconds), it is advantageous to implement the switches through the parallel mounting of MOSFET transistors.

In the foregoing description, several values were given as examples. Accordingly, the high value of the variable voltage [V1] was chosen as 21.5 volts. Naturally, this voltage may be higher, and a 42-volt system may be envisioned. However, a lower voltage makes it possible to short-circuit the DC/DC converter [4] during normal operation. In this case, thanks to the invention, a smaller and lower-power converter can be used. The power of the converter can be determined according to the operation of the arrangement according to the invention in recuperative braking mode. In order to provide approximately 3 kW at a high speed during (for example) a period of three seconds, the supercapacitor [2], for a voltage ranging between 14V and 21.5V, should have a capacitance of 67 farads. As mentioned earlier, the additional capacitance can be obtained by mounting in series a plurality of individual capacitors.

Thanks to the invention, in this case the overall power of the converter is 700 watts, as opposed to 1,400 to 1,500 watts for a 14V network.

1. Arrangement for carrying out a method for controlling a multi-phased and reversible rotating electrical machine, associated with a heat engine of a vehicle, specifically, an automobile, including a network for supplying electrical energy and a battery serving as a source of electrical energy connected to this network, as well as a command and control unit for the said electrical machine, in which overexcitation of the machine [1] for a predetermined period of time causes the production of energy, and makes this energy available for the execution of certain functions associated with the vehicle, characterized in that it includes a device for supplying the energy produced during the predetermined period of time of overexcitation of the machine; in that the device for supplying the energy is an energy storage device [9] that can be connected to the rotating electrical machine [1] by means of a switching device [6], in that it includes a DC to DC device [4] which device is mounted between the energy supply battery [2] and the energy storage device [9], downstream from the switching device [6], in that it includes a circuit [7] that can directly connect the rotating electrical machine [1] to the battery [2], and in that a switch [T1] is provided in the above-mentioned circuit [7]

2. Arrangement according to claim 1, characterized in that the switch advantageously consists of a MOSFET transistor [T1].

3. Arrangement according to claim 2, characterized in that the switching device [6] is a static switch device.

4. Arrangement according to claim 3, characterized in that the energy storage device [9] is a capacitor device, advantageously consisting of a supercapacitor with low internal resistance.

5. Arrangement according to claim 4, characterized in that the switching device includes two transistors [T1] [T2], advantageously of the MOSFET type, which are mounted head-to-tail in the output circuit of the rotating electrical machine [1].

6. Arrangement according to claim 1, characterized in that the switching device [6] consists of a diode [D], with a switch [R] mounted in series with the said diode.

7. Arrangement according to claim 6, characterized in that the above-mentioned switch [R] consists of an electromagnetic relay.
